(19) United States
(12) Patent Application Publication
(10) Pub. No.: US 2023/0206660 A1
(43) Pub. Date: Jun. 29, 2023

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: KAZUYA OGASAWARA, Kanagawa (JP); SHINJIRO HORI, Kanagawa (JP)

(21) Appl. No.: 18/064,586

(22) Filed: Dec. 12, 2022

(30) Foreign Application Priority Data
Dec. 27, 2021 (JP) 2021-212731

(51) Int. Cl. G06V 20/62; G06V 30/148; G06V 30/19; G06T 11/60

(52) U.S. Cl. CPC G06V 20/635; G06V 30/153; G06V 30/19007; G06T 11/60

(57) ABSTRACT

A method of controlling an image processing apparatus includes: obtaining a candidate image group including a plurality of images; determining a specific condition for preferentially selecting an image from the candidate image group: analyzing the images in the candidate image group; analyzing captions attached to the images in the candidate image group; and selecting a specific image from the candidate image group based on results of the determining the specific condition, the analyzing the images, and the analyzing the captions.

### BACKGROUND

### Field

The present disclosure relates to a technique of selecting an image.

### Description of the Related Art

There is an automatic layout technique in which images for album creation are automatically selected from among multiple images, a template for the album is automatically determined, and the images are automatically allocated to the template.

Japanese Patent Laid-Open No. 2018-097492 (hereinafter, referred to as Document 1) discloses a technique in which a photographic subject (hereinafter, referred to as preferred photographic subject) that is desired to be preferentially laid out and at least one sub-photographic subject are recognized, a state of the preferred photographic subject is estimated based on relationships of the recognized photographic subjects, and an image is selected based on the state of the preferred photographic subject.

Japanese Patent Laid-Open No. 2021-071870 (hereinafter, referred to as Document 2) discloses a technique in which, in the case where an album is created from images posted on a social networking service (SNS), a template or a stamp image is selected based on comments attached to the laid-out images. In this method, scores are calculated from relationships between the images and predetermined keywords to enable selection of a highly-related template or stamp image.

### SUMMARY

There is a demand for a technique of preferably selecting images.

A method of controlling an image processing apparatus according to an aspect of the present disclosure includes: obtaining a candidate image group including a plurality of images; determining a specific condition for preferentially selecting an image from the candidate image group: analyzing the images in the candidate image group; analyzing captions attached to the images in the candidate image group; and selecting a specific image from the candidate image group based on results of the determining the specific condition, the analyzing the images, and the analyzing the captions.

Further features of the present disclosure will become apparent from the following description of exemplary embodiments with reference to the attached drawings.

### BRIEF DESCRIPTION OF THE DRAWINGS

FIGS. 1A and 1B are diagrams explaining problems of a comparative example;

FIG. 2 is a block diagram illustrating a configuration of hardware of an image processing apparatus;

FIG. 3 is a software block diagram of an album creation application;

FIG. 4 is a diagram explaining an example of a UI provided by the album creation application;

FIG. 5 is a flowchart illustrating automatic layout processing;

FIG. 6 is a diagram illustrating image feature amounts;

FIG. 7 is a diagram explaining a caption automatic generation model;

FIG. 8 is a diagram illustrating caption analysis information;

FIG. 9 is a flowchart illustrating scoring processing;

FIGS. 10A to 10Q are diagrams illustrating a template group used for layout of image data;

FIG. 11 is a diagram explaining effects of an embodiment;

FIG. 12 is a flowchart illustrating the automatic layout processing;

FIG. 13 is a flowchart illustrating the scoring processing;

FIG. 14 is a flowchart illustrating the automatic layout processing;

FIG. 15 is a flowchart illustrating caption generation and analysis processing; and

FIG. 16 is a flowchart illustrating the caption generation and analysis processing.

### DESCRIPTION OF THE EMBODIMENTS

Preferable embodiments of an image processing apparatus according to the present disclosure are described below in detail according to the attached drawings. Note that the scope of the present disclosure is not limited to the illustrated examples.

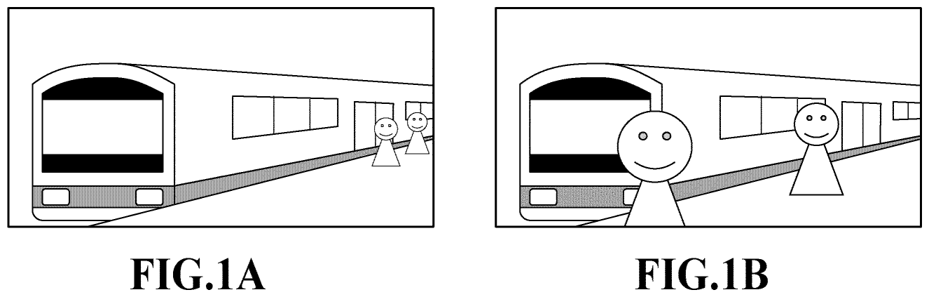

Before giving explanation of the present embodiments, image selection that uses information on a preferred photographic subject and that is performed in the case where caption analysis of an image to be described later is not used is described as a comparative example by using FIGS. 1A and 1B. FIG. 1A is an image capturing a train as a main photographic subject and FIG. 1B is an image in which a person crossing in front of a camera is accidentally captured in capturing of the image of FIG. 1A. In the case where the preferred photographic subject is set to “train”, we can assume that an image expected by a user to be automatically selected is the image of FIG. 1A, and the image of FIG. 1B should not be selected. However, in the comparative example, photographic subjects to be recognized from these images are “train” and “person” in both of FIGS. 1A and 1B. Accordingly, FIGS. 1A and 1B are both determined as images that capture “train” being the preferred photographic subject, and control of preferentially selecting FIGS. 1A and 1B is performed. Thus, in a conventional method, an image of an undesirable preferred photographic subject is sometimes selected.

In the following embodiments, description is given of a method in which obtaining of a caption linked to an image is performed in addition to the setting of the preferred photographic subject, and information obtained by analyzing the obtained caption is used to improve accuracy of the image selection. Note that, in the following embodiment, the caption is specifically a sentence set to be linked to the image. Note that the caption is added and set to the image by using an application different from an application for album creation to be described later. Specifically, the different application is, for example, an application for social networking service (SNS) that can post an image on SNS or an image management application that manages multiple images and allow the user to view the images. The user inputs a certain sentence in these applications, and the caption is thereby added and set to the image. Note that a sentence automatically generated by the application may be added and set to the image as the caption. In this case, the different application may be an application that analyzes the image and automatically adds and sets a sentence suiting the analysis result to the image as the caption. For example, the application for album creation to be described later implements the following embodiment by obtaining and analyzing the caption set by the different application as described above. Note that the caption is not limited to the aforementioned form, and may be information other than the information added by the application such as, for example, Exif information added and set to a picture image by a camera.

### First Embodiment

### <Description of System>

The present embodiment is described by giving an example in which the application for album creation is operated in an image processing apparatus 200 to generate an automatic layout. Note that, in the following description, “image” includes a still image, a moving image, and a frame image taken out from a moving image unless otherwise noted. Moreover, the image herein may include a still image, a moving image, and a frame image in a moving image that are retained on a network such as a service on the network or a storage on the network and that can be obtained via the network.

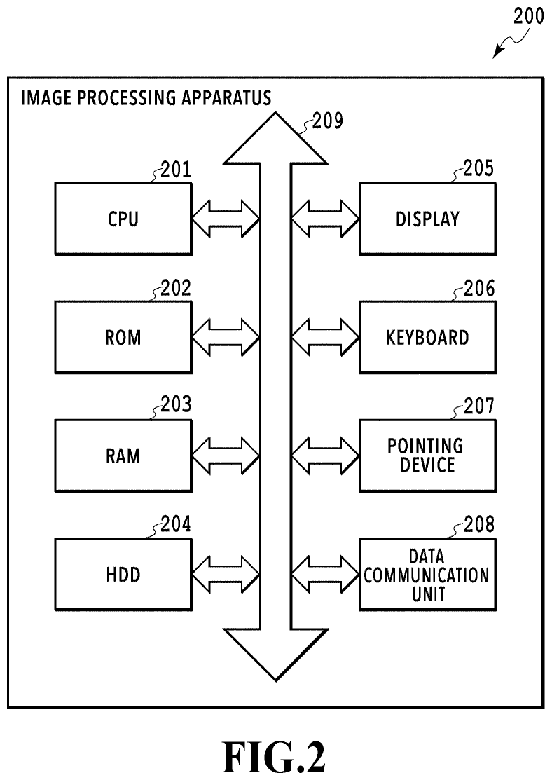

FIG. 2 is a block diagram illustrating a configuration of hardware of the image processing apparatus 200. Note that a personal computer (hereinafter, described as PC), a smartphone, and the like can be given as examples of the image processing apparatus 200. In the present embodiment, description is given assuming that the image processing apparatus 200 is a PC. The image processing apparatus 200 includes a CPU 201, a ROM 202, a RAM 203, an HDD 204, a display 205, a keyboard 206, a pointing device 207, and a data communication unit 208.

The CPU (central processing unit or processor) 201 integrally controls the image processing apparatus 200, and implements operations of the present embodiment by, for example, loading a program stored in the ROM 202 onto the RAM 203 and executing the program. In FIG. 2, there is one CPU but there may be multiple CPUs. The ROM 202 is a general-purpose ROM and stores, for example, the program to be executed by the CPU 201. The RAM 203 is a general-purpose RAM and is used as, for example, a working memory that temporarily stores various pieces of information during the execution of the program by the CPU 201. The HDD (hard disk) 204 is a storage medium (storage unit) that stores image files, a database retaining processing results of image analysis and the like, templates used by the album creation application, and the like.

The display 205 displays a user interface (UI) of the present embodiment and an electronic album as a layout result of image data (hereinafter, also referred to as “image”) to the user. The keyboard 206 and the pointing device 207 receive instruction operations from the user. The display 205 may have a touch sensor function. The keyboard 206 is used, for example, in the case where the user inputs the number of double-page spreads in an album desired to be created, on the UI displayed on the display 205. Note that “double-page spread” in the present application corresponds to one display window in display, is a region typically corresponding to two pages in printing, and indicates a pair of pages that are printed adjacent to each other on a sheet and that can be viewed by the user in one glance. The pointing device 207 is used, for example, in the case where the user clicks a button on the UI displayed on the display 205.

The data communication unit 208 performs communication with an external apparatus of an SNS, a cloud, or the like via a wired network, a wireless network, or the like. For example, the data communication unit 208 transmits data laid out by the automatic layout function to a printer or a server that is capable of communicating with the image processing apparatus 200. Moreover, the data communication unit 208 transmits data relating to automatic layout processing to be described later to an external cloud computer to partially or entirely implement the automatic layout processing in the cloud computer. A data bus 209 connects the blocks in FIG. 2 such that the blocks can communicate with one another.

Note that the configuration illustrated in FIG. 2 is merely an example, and the configuration is not limited to this. For example, the image processing apparatus 200 may include no display 205, and display the UI on an external display.

The album creation application in the present embodiment is saved in the HDD 204. As described later, the user selects an icon of the application displayed on the display 205 with the pointing device 207, and performs an operation of click or double-click to launch the application.

### <Description of Software Blocks>

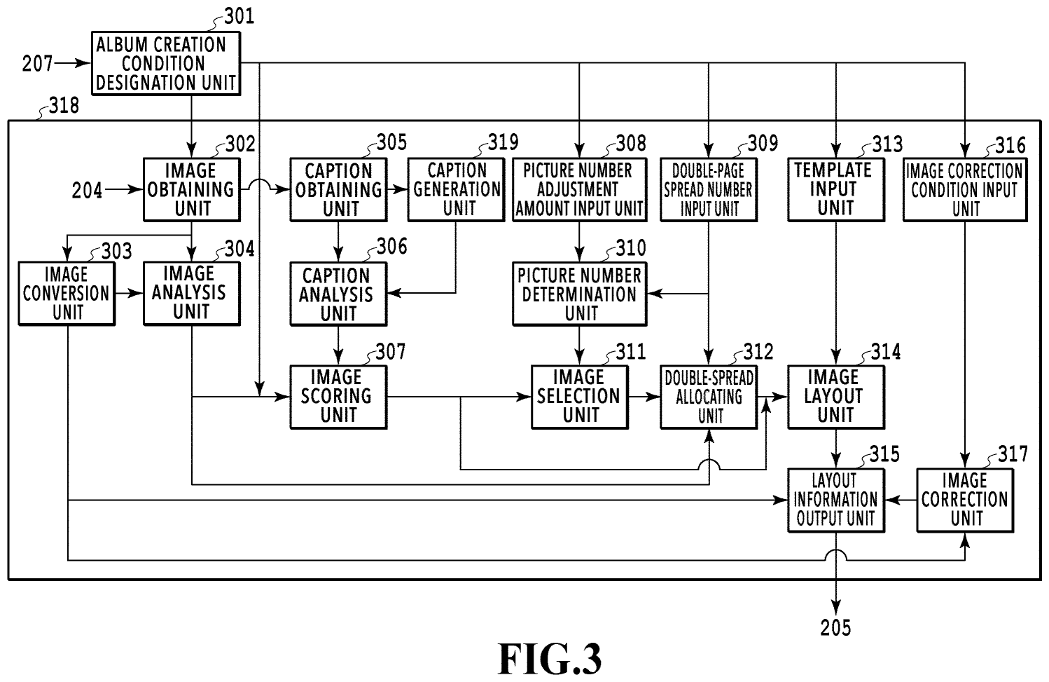

FIG. 3 is a diagram illustrating software blocks of the album creation application. The aforementioned album creation application includes program modules corresponding to the respective constituent elements illustrated FIG. 3. In the case where the CPU 201 executes the program modules, the CPU 201 functions as the constituent elements illustrated in FIG. 3. Hereinafter, the constituent elements illustrated in FIG. 3 are described assuming that the constituent elements execute various processes. Moreover, FIG. 3 particularly illustrates a software block diagram relating to an automatic layout processing unit 318 that executes the automatic layout function.

An album creation condition designation unit 301 designates album creation conditions for the automatic layout processing unit 318 in response to an UI operation on the pointing device 207. In the present embodiment, as the album creation conditions, it is possible to designate an album candidate image group including candidate images to be used in an album, the number of double-page spreads, a type of template, and which one of a person or a pet a preferential photographic subject of images to be employed in the album is. Moreover, it is possible to designate a theme of the album to be created, conditions such as whether or not to perform image correction on the album, a picture number adjustment amount for adjusting the number of pictures to be arranged in the album, and a product on which the album is to be created. In the designation of the album candidate image group, the designation can be made by using attribute information of each of individual images such as, for example, image capturing time and date, or based on a structure of a file system including the image such as a device or a directory. Moreover, the designation may be such that any two images are designated and all images captured between the image capturing times and dates of these images are set as a target image group.

An image obtaining unit 302 obtains the album candidate image group designated by the album creation condition designation unit 301 from the HDD 204. The image obtaining unit 302 outputs image width or height information included in each of the obtained images, image capturing time and date information included in the Exif information created in image capturing, information indicating whether or not the image is included in a user image group, or the like, to an image analysis unit 304 as meta information (data additionally accompanying the image). Moreover, the image obtaining unit 302 outputs the obtained image data to an image conversion unit 303. Identification information is appended to each image, and the meta information outputted to the image analysis unit 304 and the image data outputted to the image analysis unit 304 via the image conversion unit 303 to be described later can be associated with each other in the image analysis unit 304.

The images saved in the HDD 204 include still images and frame images cut out from moving images. The still images and the frame images are images obtained from an image capturing device such as a digital camera or a smart device. The image capturing device may be a device included in the image processing apparatus 200 or a device included in an external apparatus. In the case where the image capturing device is the device included in an external apparatus, the images are obtained via the data communication unit 208. Moreover, the still images and the cut-out images may be images obtained from a network or a server via the data communication unit 208. The images obtained from the network or the server include SNS images. The program executed by the CPU 201 analyzes data accompanying each image and determines a file source of each image. The SNS images may be such that images are obtained from an SNS via the application and the obtaining sources of the images are managed in the application. The images are not limited to the aforementioned images and may be another type of images.

The image conversion unit 303 converts the image data received from the image obtaining unit 302 into an image with a certain number of pixels and color information for use in the image analysis unit 304, and outputs the image to the image analysis unit 304. In the present embodiment, each image is converted to an image in which a shorter side has a predetermined number of pixels (for example, 420 pixels) and a longer side has such a size that the original ratio between the sides is maintained. Moreover, the image conversion unit 303 performs conversion such that color spaces are unified to sRGB or the like for color analysis. As described above, the image conversion unit 303 converts the images to analysis images with a uniform number of pixels and a uniform color space. The image conversion unit 303 outputs the converted images to the image analysis unit 304. Moreover, the image conversion unit 303 outputs the images to a layout information output unit 315 and an image correction unit 317.

The image analysis unit 304 performs image data analysis on each of the analysis images received from the image conversion unit 303 by a method to be described later, and obtains image feature amounts. The image feature amounts are, for example, feature amounts that can be obtained by analyzing the image or the meta information stored in the image. As analysis processing, the image analysis unit 304 executes various processes including estimation of a degree of in-focus, face detection, personal recognition, and object detection, and obtains the image feature amounts for these processes. Other image feature amounts include tint, brightness, resolution, a data amount, a degree of defocused state or shaking, and the like, and image feature amounts other than those described above may be obtained. The image analysis unit 304 extracts necessary pieces of information from the meta information received from the image obtaining unit 302 together with the aforementioned image feature amounts, combines these pieces of information, and outputs the combination to an image scoring unit 307 as feature amounts. Moreover, the image analysis unit 304 outputs the image capturing time and date information to a double-spread allocating unit 312.

A caption obtaining unit 305 obtains a caption accompanying each of the obtained images, and outputs the caption to a caption analysis unit 306. A caption generation unit 319 generates a caption for an image not accompanied by a caption by applying a known caption generation model to the image, and outputs the caption to the caption analysis unit 306.

The caption analysis unit 306 analyzes each of the captions received from the caption obtaining unit 305 by a method to be described later to obtain caption analysis information, and outputs the caption analysis information to the image scoring unit 307.

The image scoring unit 307 gives a score to each image in the album candidate image group by using the feature amounts obtained from the image analysis unit 304 and the caption analysis information obtained from the caption analysis unit 306. The score herein is an index indicating suitableness of each image for a layout and, the higher the score is, the more suitable the image is for the layout. The result of scoring is outputted to an image selection unit 311 and an image layout unit 314.

A picture number adjustment amount input unit 308 inputs the adjustment amount for adjusting the number of pictures to be arranged in the album that is designated by the album creation condition designation unit 301, into a picture number determination unit 310. A double-page spread number input unit 309 inputs the number of double-page spreads in the album that is designated by the album creation condition designation unit 301, into the picture number determination unit 310 and the double-spread allocating unit 312. The number of double-page spreads in the album corresponds to the number of multiple templates in which multiple images are to be arranged.

The picture number determination unit 310 determines the total number of pictures forming the album, based on the adjustment amount designated by the picture number adjustment amount input unit 308 and the number of double-page spreads designated by the double-page spread number input unit 309, and inputs the total number in the image selection unit 311.

The image selection unit 311 selects images based on the number of pictures received from the picture number determination unit 310 and the score calculated in the image scoring unit 307 to create a layout image group to be used in the album, and provides the list to the double-spread allocating unit 312.

The double-spread allocating unit 312 allocates each image to a corresponding a double-page spread by using the image capturing time and date information for the image group selected in the image selection unit 311. Although an example in which the images are allocated in units of double-page spreads is described herein, the images may be allocated in units of pages.

A template input unit 313 reads multiple templates from the HDD 204 depending on the template information designated by the album creation condition designation unit 301, and inputs the templates into the image layout unit 314.

The image layout unit 314 performs layout processing of images in each double-page spread. Specifically, for a double-page spread to be processed, the image layout unit 314 determines a template suitable for the images selected in the image selection unit 311, from among the multiple templates received from the template input unit 313, and determines the layout of the images.

The layout information output unit 315 outputs layout information to be displayed on the display 205, according to the layout determined by the image layout unit 314. The layout information is, for example, a bitmap data in which pieces of data of selected images selected by the image selection unit 311 are laid out on the determined template.

An image correction condition input unit 316 provides the ON/OFF information on the image correction designated by the album creation condition designation unit 301, to the image correction unit 317. Types of correction include, for example, luminance correction, dodging correction, red-eye correction, contrast correction, and the like. ON or OFF of the image correction may be designated for each type of correction or collectively designated for all types of correction.

The image correction unit 317 executes correction on the layout information retained by the layout information output unit 315, based on the image correction condition received from the image correction condition input unit 316. Note that the number of pixels in each image that is transmitted from the image conversion unit 303 and that is to be processed in the image correction unit 317 can be changed according to a size of a layout image determined in the image layout unit 314. Although the image correction is performed on each image after the generation of the layout image in the present embodiment, the image correction is not limited to this. Each image may be corrected before being laid out on the double-page spread or the page.

In the case where the album creation application is installed into the image processing apparatus 200, a launch icon is displayed on a top screen (desktop) of an operating system (OS) operating on the image processing apparatus 200. In the case where the user double-clicks the launch icon displayed on the display 205 with the pointing device 207, the program of the application saved in the HDD 204 is launched by being loaded onto the RAM 203 and executed by the CPU 201.

Note that all or some of the functions of the constitutional elements of the software blocks may be implemented by using a dedicated circuit. Alternatively, all or some of the functions of the constitutional elements of the software blocks may be implemented by using a cloud computer.

### <Example of UI Screen>

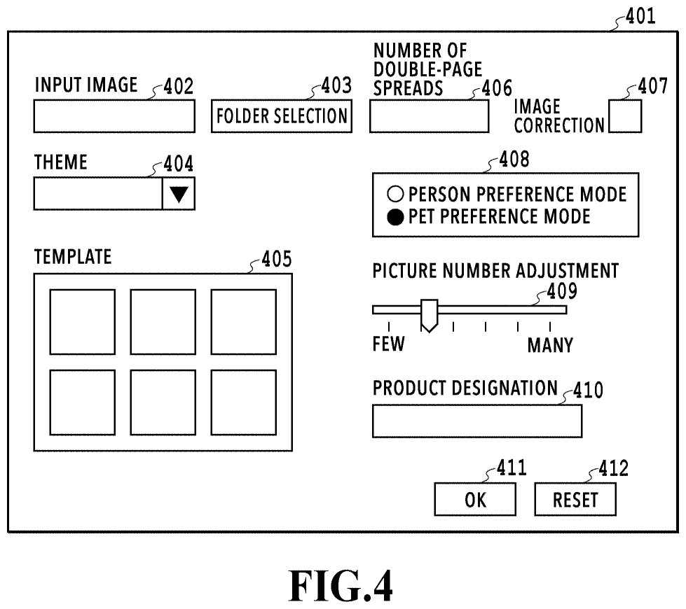

FIG. 4 is a diagram illustrating an example of an application launch screen 401 provided by the album creation application. The application launch screen 401 is displayed on the display 205. The user sets creation conditions of the album to be described later through the application launch screen 401. The album creation condition designation unit 301 obtains setting contents from the user through this UI screen.

A path box 402 on the application launch screen 401 displays a save location (path) of multiple images (for example, multiple image files) to be targets of album creation in the HDD 204. A folder selection screen that the OS has as a default is displayed in the case where an instruction is given on a folder selection button 403 by a click operation from the user with the pointing device 207. In the folder selection screen, folders set in the HDD 204 are displayed in a tree structure, and the user can select a folder including images to be the targets of album creation by using the pointing device 207. The path of the folder in which the album candidate image group selected by the user is stored is displayed in the path box 402.

A theme selection dropdown list 404 receives a setting of a theme from the user. The theme is an index for bringing a sense of uniformness to the images to be laid out, and is, for example, “trip”, “ceremony”, “daily-life”, or the like. A template designation region 405 is a region in which the user designates the template information, and the template information is displayed as an icon. In the template designation region 405, icons of multiple pieces of template information are displayed side by side, and the user can select a piece of template information by clicking the icon with the pointing device 207.

A double-page spread number box 406 receives a setting of the number of double-page spreads in the album from the user. The user directly inputs a number into the double-page spread number box 406 via the keyboard 206, or inputs a number into the double-page spread number box 406 from a list by using the pointing device 207.

A check box 407 receives designation of ON/OFF of the image correction from the user. A checked state is a state where the image correction ON is designated, and an unchecked state is a state where the image correction OFF is designated. Although all types of image correction are turned ON or OFF by one button in the present embodiment, ON/OFF designation is not limited to this. A check box may be provided for each type of image correction.

A preference mode selection button 408 receives a setting of a preference mode from the user, the preference mode indicating whether to preferentially select person images or pet images in the album to be created. Although the preference mode is selected from two modes of person and pet in the present embodiment, the modes are not limited to this. For example, there may be other modes such as, for example, landscape, vehicle, and food. The image scoring unit 307 determines the preferred photographic subject based on the preference mode set herein, the preferred photographic subject used as a reference in the case where correction or the like is performed in scoring of the images.

A picture number adjustment 409 is a portion for adjusting the number of images to be arranged in each double-page spread of the album with a slider bar. The user can adjust the number of images to be arranged in each double-page spread of the album by moving the slider bar to right and left. In the picture number adjustment 409, for example, appropriate numbers such as −5 and +5 are assigned for few and many to enable adjustment of the number of images arrangeable in the double-page spread. Note that a form in which the user inputs the number of pictures without using the slider bar may be employed.

In a product designation portion 410, a product on which the album is to be created is set. The size of the album and a type of sheets of the album can be set for the product. Moreover, a type of a cover sheet and a type of a binding portion may be set individually.

In the case where the user presses an OK button 411, the album creation condition designation unit 301 outputs the contents set on the application launch screen 401 to the automatic layout processing unit 318 of the album creation application.

In this case, the path inputted in the path box 402 is transmitted to the image obtaining unit 302. Moreover, the number of double-page spreads inputted in the double-page spread number box 406 is transmitted to the double-page spread number input unit 309. The template information selected in the template designation region 405 is transmitted to the template input unit 313. The ON/OFF of image correction in the image correction check box 407 is transmitted to the image correction condition input unit 316. A reset button 412 on the application launch screen 401 is a button for resetting the pieces of setting information on the application launch screen 401.

### <Flow of Processing>

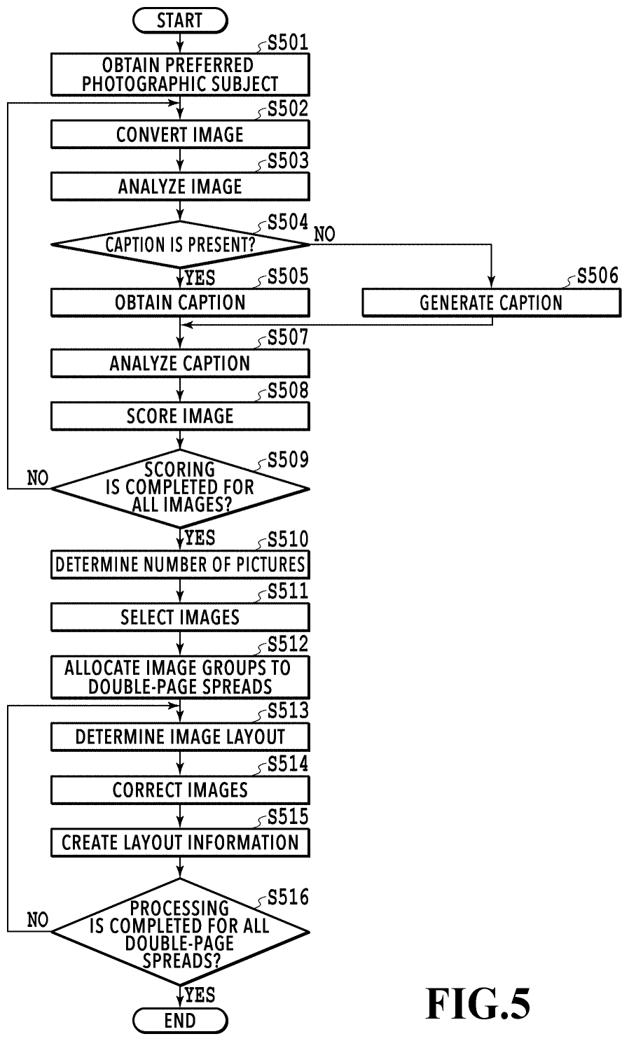

FIG. 5 is a flowchart illustrating processing of the automatic layout processing unit 318 in the album creation application. For example, the CPU 201 loads the program stored in the HDD 204 onto the RAM 203, and executes the program to implement the flowchart illustrated in FIG. 5. FIG. 5 is described assuming that the processing is executed by the constitutional elements illustrated in FIG. 3, the constitutional elements caused to function by the execution of the aforementioned album creation application by the CPU 201. Automatic layout processing is described with reference to FIG. 5. Symbol “S” in explanation of each process means step in the flowchart (the same applies to the present embodiment and beyond).

In S501, the image scoring unit 307 determines the preferred photographic subject based on the preference mode information specified in the album creation condition designation unit 301. For example, in the case where the person preference mode in which person images are preferentially selected is designated, the image scoring unit 307 determines photographic subjects relating to persons such as “person”, “man”, “woman”, and “child” as the preferred photographic subjects. Meanwhile, in the case where the pet preference mode in which pet images are preferentially selected is designated, the image scoring unit 307 determines photographic subjects relating to pets such as “pet”, “dog”, “cat”, and “hamster” as the preferred photographic subjects. As described above, in S501, the image scoring unit 307 determines at least one preferred photographic subject linked to the designated preference mode.

Although the preferred photographic subject is determined based on the preference mode designated in the preference mode selection button 408 in the present embodiment, the configuration is not limited to this. For example, the user may designate any preferred photographic subject through a not-illustrated preferred photographic subject box. Moreover, the preferred photographic subject may be determined based on the theme designated in the theme selection dropdown list 404.

In S502, the image conversion unit 303 converts the images and generates the analysis images. The images used in analysis herein are the images in the album candidate image group that is stored in the folder in the HDD 204 and that is designated in the album creation condition designation unit 301. Accordingly, at the point of S502, it is assumed that the various settings through the UI screen of the application launch screen 401 are completed, and the album creation conditions and the album candidate image group are already set. The image conversion unit 303 loads the album candidate image group from the HDD 204 onto the RAM 203. Then, the image conversion unit 303 converts the images of the loaded image file to the analysis images each having the predetermined number of pixels and color information as described above. In the embodiment, each image is converted to an analysis image in which the short side has 420 pixels and that has the color information converted to sRGB.

In S503, the image analysis unit 304 executes processing of analyzing the analysis images generated in S502, and obtains the image feature amounts. In the present embodiment, obtaining of the degree of in-focus, face detection, personal recognition, and object detection are executed as the analysis processing. However, the analysis processing is not limited to this and other types of analysis processing may be executed. Details of processing performed in the image analysis unit 304 in S503 are described below.

The image analysis unit 304 extracts necessary pieces of meta information among the pieces of meta information received from the image obtaining unit 302. For example, the image analysis unit 304 obtains the image capturing time and date from the Exif information accompanying each of the image files read from the HDD 204, as time information of the image in the image file. Note that, for example, the position information, the f-number, or the like of the image may be obtained as the meta information. Moreover, information other than the information accompanying the image file may be obtained as the meta information. For example, schedule information linked to the image capturing time and date of the image may be obtained.

Moreover, as described above, the image analysis unit 304 obtains the image feature amounts from the analysis images generated in S502. The image feature amounts include, for example, the degree of in-focus. Edge detection is performed as a method for obtaining the degree of in-focus. A Sobel filter is generally known as the edge detection method. The edge detection is performed by using the Sobel filter, and a luminance difference between a start point and an end point of an edge is divided by a distance between the start point and the end point to calculate a gradient of the edge. An average gradient of edges in the image is calculated. From the result of this calculation, it is possible to assume that an image with a large average gradient is an image that is more in-focus than an image with a small average gradient. In the case where multiple thresholds with different values are set for the gradient, it is possible to determine which one of the thresholds the calculated gradient is equal to or higher than, and an evaluation value of an in-focus degree can be outputted. In the present embodiment, two different thresholds are set in advance, and the in-focus degree is determined in three levels of “good”, “fair”, and “poor”. For example, the thresholds are set in advance such that “good” is determined to be a gradient at which an image has such an in-focus degree that that the image is desired to be adopted in the album, “fair” is determined to be a gradient at which the image has an acceptable in-focus degree, and “poor” determined to be a gradient at which the image has an unacceptable in-focus degree. The setting of the thresholds may be provided by, for example, a creator or the like of the album creation application, or may be settable on a user interface. Note that, for example, the brightness, tint, chroma, resolution, or the like of the image may be obtained as the image feature amounts.

Moreover, the image analysis unit 304 executes the face detection on the analysis images generated in S502. A publicly-known method can be used for the face detection processing herein. For example, AdaBoost that creates a strong discriminator from multiple prepared weak discriminators is used for the face detection processing. In the present embodiment, the strong discriminator created by AdaBoost detects a face image of a person (object). The image analysis unit 304 extracts the face image, and obtains a coordinate value of an upper-left position and a coordinate value of a lower-right position of the detected face image. Obtaining these two types of coordinates allows the image analysis unit 304 to obtain the position of the face image and the size of the face image.

The image analysis unit 304 performs the personal recognition by comparing the face image that is detected in the face detection and that is included in a processing target image based on the analysis image, with a typical face image saved for each personal ID in a face dictionary database. The image analysis unit 304 obtains similarity with the face image in the processing target image, for each of multiple typical face images. Moreover, the image analysis unit 304 specifies a typical face image that has a similarity equal to or higher than a threshold and that has the highest similarity. Then, the image analysis unit 304 sets a personal ID corresponding to the specified typical face image as an ID of the face image in the processing target image. Note that, in the case where the similarity with the face image in the processing target image is smaller than the threshold for all of the aforementioned multiple typical face images, the image analysis unit 304 registers the face image in the processing target image as a new typical face image in the face dictionary database in association with a new personal ID.

Moreover, the image analysis unit 304 executes the object recognition on the analysis images generated in S502. A publicly-known method can be used for the object recognition processing herein. In the present embodiment, a determiner created by Deep Learning recognizes objects. The determiner outputs a likelihood of 0 to 1 for each object, and recognizes that an object with a likelihood exceeding a certain threshold is included in the image. The image analysis unit 304 can obtain a type of the object such as flower, food, building, figurine, landmark, or pet such as dog and cat by recognizing the object image. Although the object determination is performed in the present embodiment, the configuration is not limited to this. A facial expression, a photographic composition, and a scene such as trip or wedding ceremony can be recognized to obtain the type thereof. Moreover, the likelihood itself before the execution of the determination that is outputted from the determiner may be used.

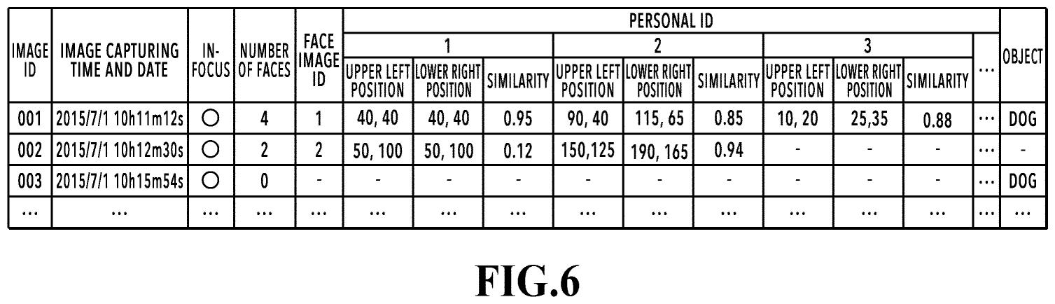

FIG. 6 is a diagram illustrating the image feature amounts. The image analysis unit 304 distinguishes the image feature amounts obtained in S503 depending on IDs that identify the respective images (analysis images) as illustrated in FIG. 6, and stores the image feature amounts in a storage region of the ROM 202 or the like. For example, as illustrated in FIG. 6, the image capturing time and date information, the in-focus determination result, the number of detected faces, the position information and similarity of the detected face, and the type of the recognized object obtained in S503 are stored in a table form. Note that the pieces of position information of the face images are stored while being distinguished depending on the personal IDs obtained in S503. Moreover, in the case where multiple types of objects are recognized in one image, the multiple types of objects are all stored in a row corresponding to this one image in the table illustrated in FIG. 6.

In S504, the caption obtaining unit 305 determines whether or not each image is accompanied by a caption. In the case where the caption obtaining unit 305 determines that the image is accompanied by a caption, the processing proceeds to S505. In the case where the caption obtaining unit 305 determines that the image is not accompanied by a caption, the processing proceeds to S506.

In S505, the caption obtaining unit 305 obtains the caption accompanying the image. Note that, in the case where the caption is a caption given by the user or in the case where there is a history of attaching the caption in past album creation or the like and the caption is attached to the image, the caption obtaining unit 305 obtains data of this caption.

In S506, the caption generation unit 319 automatically generates a caption of the image by using a known caption generation model. The method of automatically generating a caption is not limited to a particular method. In the present embodiment, a Show and Tell model described in Oriol Vinyals, Alexander Toshev, Samy Bengio, and Dumitru Erhan. “Show and Tell: A Neural Image Caption Generator”, 2015 IEEE Conference on Computer Vision and Pattern Recognition (CVPR), 2015, pp. 3156-3164 is used to automatically generate a caption.

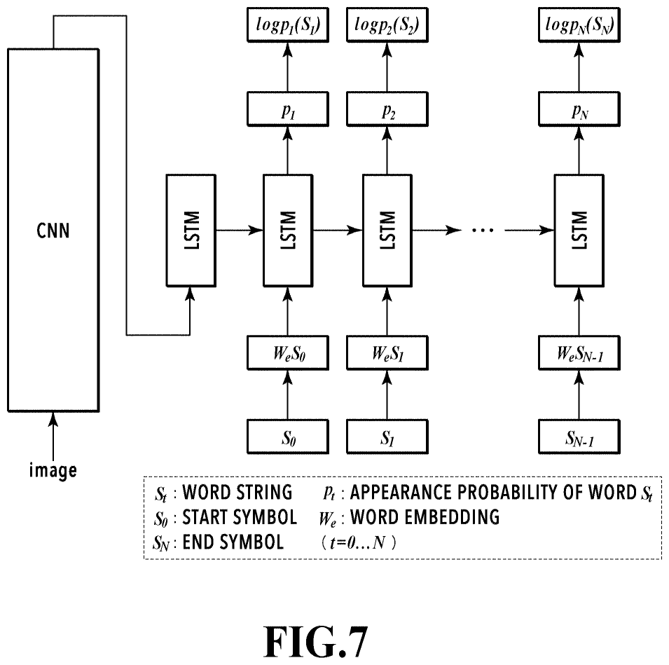

FIG. 7 is a diagram explaining the caption generation model by giving the Show and Tell model as an example. The caption generation model is configured to be broadly classified into three networks. The three networks are a convolutional neural network (CNN), a word embedding We, and a long short-term memory (LSTM). The CNN converts an image into a feature amount vector. The word embedding We converts a word into a feature amount vector. The LSTM outputs an appearance probability of the next word. In the generation of a caption, an image is first inputted into the CNN. Then, a feature amount vector obtained by the input is inputted into the LSTM to sequentially obtain appearance probabilities of words from the beginning of a sentence. A word string in which a product of the appearance probabilities of the words is great is outputted as a caption sentence.

In S507, the caption analysis unit 306 analyzes the caption obtained in S505 and the caption created in S506, and obtains the caption analysis information. In the present embodiment, syntax analysis is executed as the analysis processing. The syntax analysis is processing of segmenting a language into morphemes and clarifying syntactic relationships between the morphemes. A publicly-known method such as an operator precedence method, a top-down syntax analysis method, or a bottom-up syntax analysis method may be used as means for implementing the syntax analysis. The caption analysis unit 306 performs the syntax analysis on the caption obtained in S505 and the caption generated in S506 to obtain elements such as a subject, a verb, an object, or a complement in the captions.

In the present embodiment, the caption analysis processing is then terminated, but further analysis processing may be performed on the words of elements obtained in the syntax analysis. For example, the word being the elements may be converted to a word embedding by using a publicly-known technique. The word embedding is a representation method in which a character or a word is embedded in a vector space and is viewed as one point in the vector space. The publicly-known technique includes, for example, Word2Vec described in Tomas Mikolov, Kai Chen, Greg S. Corrado, and Jeffrey Dean “Efficient Estimation of Word Representations in Vector Space”, International Conference on Learning Representations (ICLR), 2013.

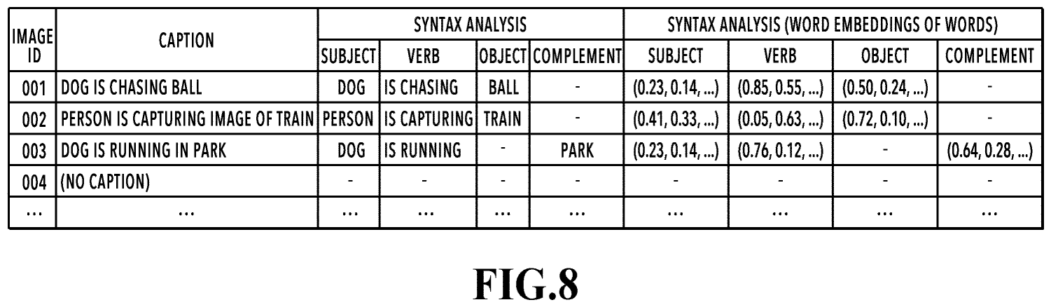

FIG. 8 is a diagram illustrating the caption analysis information. The caption analysis unit 306 distinguishes the piece of caption analysis information obtained in S507 depending the IDs identifying the respective images as illustrated in FIG. 8, and stores the caption analysis information in a storage region of the ROM 202 or the like. For example, as illustrated in FIG. 8, the elements of subject, verb, object, and complement obtained in S507 are stored in a table form. Note that FIG. 8 also illustrates an example in the case where words are converted to word embeddings.

In S508, the image scoring unit 307 executes scoring for each of the images in the album candidate image group. The score described herein is an index indicating suitableness of each image for the layout. The scoring is giving the score to each image. The given scores are provided to the image selection unit 311, and are referred to in selection of images to be used in the layout to be described later.

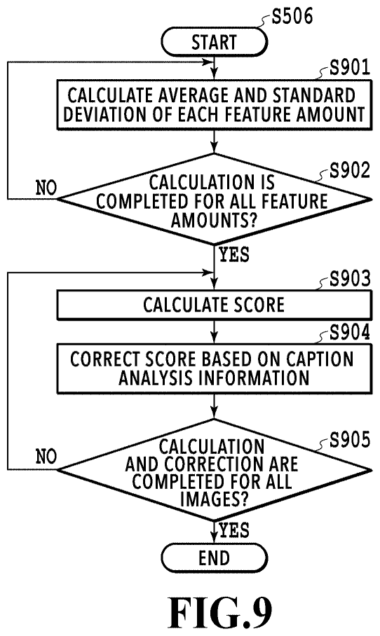

FIG. 9 is a flowchart illustrating details of the scoring processing of S508. The scoring processing performed in S508 is described below by using FIG. 9.

First, in S901, for each of the image feature amounts obtained in S503, the image scoring unit 307 calculates an average value and a standard deviation of the image feature amount in the album candidate image group. In S902, the image scoring unit 307 determines whether or not the processing of S901 is completed for all image feature amount items. In the case where the image scoring unit 307 determines that the processing is not completed, the processing from S901 is repeated. In the case where the image scoring unit 307 determines that the processing completed, the processing proceeds to S903.

In S903, the image scoring unit 307 calculates the score for each of images that are targets of scoring (referred to as “interest images”) by using a formula (1) described below. Note that the images that are the targets of scoring are the images in the album candidate image group.

Sji=50−|10×(μi−fji)/σi| formula (1)

In this formula, j is an index of the interest image, i is an index of the image feature amount, fji is an image feature amount of the interest image, and Sji is a score corresponding to the image feature amount fji. Moreover, μi and σi are the average value and the standard deviation of each image feature amount in the album candidate image group, respectively. Then, the image scoring unit 307 calculates a score of each interest image by using a formula (2) described below and the score Sji of each image feature amount for each interest image obtained in the formula (1).

Pj=Σi(Sji)/Ni formula (2)

In this formula, Pj is the score of each interest image, and Ni is the number of items of the image feature amounts. Specifically, the score of each interest image is calculated as an average of the scores of the respective image feature amounts. Note that, since an image in focus is more preferable as an image to be used in the album, a predetermined score may be added for an interest image in which the in-focus feature amount illustrated in FIG. 7 is “good”.

In S904, the image scoring unit 307 corrects each score calculated in S903, based on the caption analysis information obtained in S507. The correction method includes a method in which the score calculated in S903 is increased in the case where the information on the subject obtained in S507 matches the information on the preferred photographic subject set in S501. The subject in the caption added by the user is important information that determines an important photographic subject in the image, and a photographic subject being the subject in the caption is viewed as a main photographic subject. Thus, according to this method, it is possible to perform such scoring that a desirable image of a preferred photographic subject such as an image in which a photographic subject desired to be preferentially laid out is an important photographic subject in the image is more likely to be selected. In the present embodiment, the score of the image for which the information on the subject matches the information on the preferred photographic subject is increased by, for example, 20 points. However, the increase value may be different from that described above.

Moreover, as another correction method, there may be used a method in which the score calculated in S903 is reduced in the case where the information on the subject does not match the information on the preferred photographic subject. According to this method, it is possible to perform such control that an image of a preferred photographic subject in which the photographic subject desired to be preferentially laid out is not an important photographic subject in the image and that is undesirable for layout is less likely to be selected.

In the aforementioned correction method, the score is corrected based on whether or not the information on the subject matches the information on the preferred photographic subject. However, the information on the subject does not have to completely match the preference mode of the photographic subject selected in the preference mode selection button 408 in FIG. 4, and the score may be corrected based whether or not the information on the subject is synonym to the preference mode. For example, in the case where the “pet preference mode” is selected in the preference mode selection button 408 of FIG. 4, the score may be corrected based on whether the subject matches information such as “dog” or “cat” that is synonym to “pet”. According to this method, more flexible score correction is possible. Specific methods include, for example, the following method. Whether or not the preferred photographic subject and the subject are synonym to each other is determined by using publicly-known WordNet and, in the case where they are synonym to each other, the score is increased. Moreover, the method may be such that synonymous relationships among words are retained in advance in the ROM 202, and are searched to determine whether the preferred photographic subject and the subject are in the synonymous relationship.

Moreover, in the case where the caption obtaining unit 305 determines that the image is not accompanied by a caption in S504, the image scoring unit 307 may reduce the score calculated in S903 instead of proceeding to the caption generation step (S506). The image to which the user adds no caption can be considered as an image that is less important to the user than the image to which the user adds the caption. Thus, according to this method, reducing the score of the image to which no caption is added makes it more likely for the image to which the caption is added and that is important to the user to be selected than the other images.

Oppositely, the score of the image determined to be accompanied by a caption in S504 may be increased. According to this method, increasing the score of the image accompanied by a caption makes it more likely for the image to which the caption is added and that is important to the user to be selected.

Moreover, in the case where the words are expressed in the word embedding, in S505, the score may be corrected based on a relationship between the preferred photographic subject and the obtained subject subjected to the word embedding on the space vector. For example, the score may be increased in the case where a distance between the preferred photographic subject and the obtained subjected on the space vector is equal to or less than a certain threshold. According to this method, the score can be corrected based not on whether the preferred photographic subject and the obtained subject completely match each other, but on whether both words are similar to each other in terms of meaning. Note that, in this case, the word of the preferred photographic subject is desirably converted in advance to the word embedding before S904.

In S905, the image scoring unit 307 determines whether or not the processing of S903 and S904 are completed for all images in the album candidate image group in the folder designated by the user. In the case where the image scoring unit 307 determines that the processing not completed, the processing from S903 is repeated. In the case where the image scoring unit 307 determines that the processing is completed, the scoring processing of FIG. 9 is terminated.

Returning to the description of FIG. 5, following S508, in S509, the image scoring unit 307 determines whether the image scoring of S508 is completed for all images in the album candidate image group in the folder designated by the user. In the case where the image scoring unit 307 determines that the processing is not completed, the processing from S502 is repeated. In the case where the image scoring unit 307 determines that the processing is completed, the processing proceeds to S510.

In S510, the picture number determination unit 310 determines the number of pictures to be arranged in the album. In the present embodiment, the number of pictures to be arranged in the album is determined from a formula (3) by using the adjustment amount for adjusting the number of pictures in each double-page spread inputted from the picture number adjustment amount input unit 308 and the number of double-page spreads inputted from the double-page spread number input unit 309.

Number of pictures=[number of double-page spreads×(normal number of pictures+adjustment amount)] formula (3)

In this formula, [·] is a floor function in which a number is rounded down to the nearest integer, and the normal number of pictures is the number of images to be arranged in the double-page spread in the case where no adjustment is performed. In the present embodiment, the normal number of pictures is set to six in consideration of appearance in the layout, and is incorporated in advance in the program of the album creation application.

In S511, the image selection unit 311 selects images to be laid out based on the scores calculated in the image scoring unit 307 and given to the respective images and the number of pictures determined in the picture number determination unit 310. A group of the selected images is hereinafter referred to as layout image group. In the present embodiment, the image selection unit 311 select as many images as the total number of images to be laid out, from the image group designated in the album creation condition designation unit 301, in descending order of scores given in the image scoring unit 307. Note that the following method may be employed as the method of image selection. The higher the score of the image is, the higher the selection probability is set for the image, and the images are selected based on the probabilities. Selecting the images based on the probability as described above can change the layout images every time the automatic layout function is executed by the automatic layout processing unit 318. For example, in the case where the user is not satisfied with the automatic layout result, the user may press a not-illustrated reselection button in the UI to obtain a layout result different from the previous result.

Moreover, in the image selection unit 311, the image whose score calculated in the image scoring unit 307 is equal to or higher than a certain threshold may be selected as the layout image. In this case, the number of pictures does not have to be determined in the picture number determination unit 310. In this case, a value at which the number of selected images is equal to the number of double-page spreads is an upper limit of the threshold that can be set.

In S512, the double-spread allocating unit 312 divides the layout image group obtained in S511 into image groups as many as the number of double-page spreads received from the double-page spread number input unit 309, and allocates the image groups. In the present embodiment, the layout images are arranged in the order of image capturing time obtained in S503, and are divided at a point where a time difference in image capturing time between adjacent images is large. Such processing is performed until the layout image group is divided into image groups as many as the number of double-page spreads received from the double-page spread number input unit 309. Specifically, division is performed (number of double-page spreads−1) times. An album in which images are arranged in the order of image capturing time can be thereby created. Note that the processing of S512 may be performed in units of pages instead of units of double-page spreads.

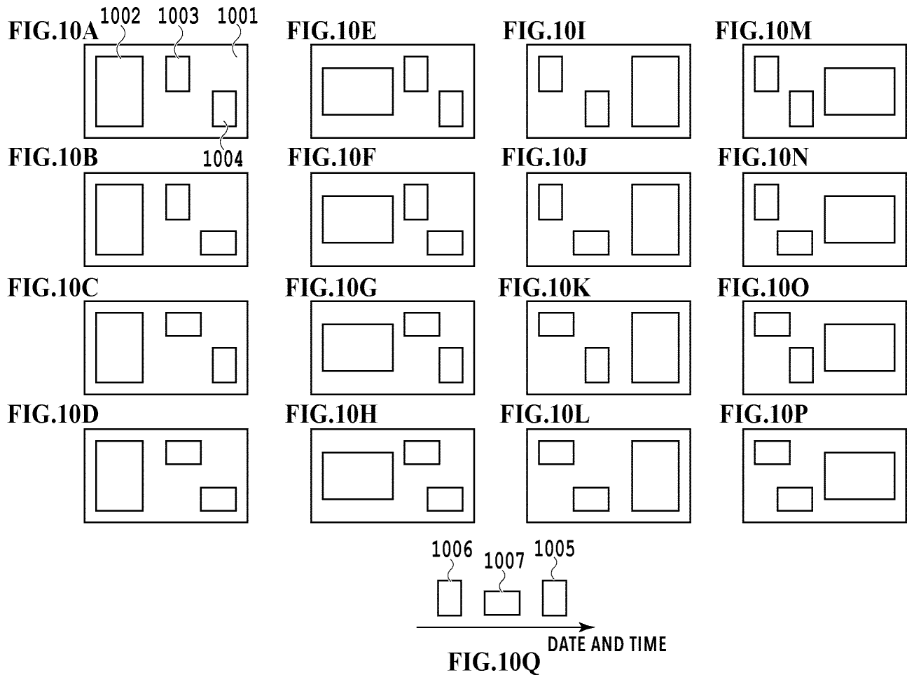

In S513, the image layout unit 314 determines image layout. Description is given below of an example in which the template input unit 313 inputs templates of FIGS. 10A to 10P for certain double-page spreads according to designated template information.

FIGS. 10A to 10P are diagrams illustrating a template group used for the layout of the image data. Multiple templates included in the template group correspond to the respective double-page spreads. A template 1001 is one template. The template 1001 includes a main slot 1002, a sub-slot 1003, and a sub-slot 1004. The main slot 1002 is a slot (frame in which an image is laid out) to be a main portion in the template 1001, and has a size larger than those of the sub-slot 1003 and the sub-slot 1004.

In this case, the number of slots in each of the inputted templates is designated to be three as an example. FIG. 10Q is a diagram in which three images selected according to the designated number for the template are arranged in the order of image capturing time and date. Moreover, the three images are arranged with orientations thereof (portrait orientated or landscape oriented) distinguished.

In this case, an image with the highest score calculated in the image scoring unit 307 in the image group allocated to each double-spread page is set as an image for the main slot and the other images are set as images for the sub-slots. Note that the image for the main slot and the images for the sub-slots may be set based on the certain image feature amounts obtained in the image analysis unit 304, or may be randomly set.

Here, assume that image data 1005 is the image for the main slot and image data 1006 and image data 1007 are the images for the sub-slots. In the present embodiment, image data with older image capturing time and date is laid out in an upper left portion of the template (main slot 1002 in the case of the template 1001) and an image with newer image capturing time and date is laid out in a lower right portion (sub-slot 1004 in the case of the template 1001). In FIG. 10Q, the image data 1005 for the main slot is portrait-oriented and has the newest image capturing time and date. Accordingly, the image data 1005 is laid out such that a lower right portion of the template is the main slot. The templates of FIGS. 10I to 10L are thus candidates. Moreover, the image data 1006 that is the older one of the images for the sub-slots is a portrait-oriented image, and the image data 1007 that is the newer one is a landscape-oriented image. As a result, the image layout unit 314 determines that the template of FIG. 10J is the template most suitable for the selected three pieces of image data, and determines the layout. In S513, the image layout unit 314 determines which image is to be laid out in which slot of which template.

In S514, the image correction unit 317 executes the image correction. In the case where the image correction unit 317 receives information indicating that the image correction is ON from the image correction condition input unit 316, the image correction unit 317 executes the image correction. For example, dodging correction (luminance correction), red-eye correction, or contrast correction is executed as the image correction. In the case where the image correction unit 317 receives information indicating that the image correction is OFF from the image correction condition input unit 316, the image correction unit 317 does not execute the image correction. The image correction can be executed also on, for example, image data converted to a color space of sRGB and converted to such a size that the short side is 1200 pixels.

In S515, the layout information output unit 315 creates the layout information. The image layout unit 314 lays out the pieces of images data subjected to the image correction of S514 to the respective slots in the template determined in S513. In this case, the image layout unit 314 lays out the pieces of image data while changing the scales of the laid-out pieces of image data according to size information of the slots. Then, the layout information output unit 315 generates a bitmap data in which the pieces of image data are laid out to the template, as an output image.

In S516, the image layout unit 314 determines whether the processing from S513 to S515 is completed for all double-page spreads. In the case where the image layout unit 314 determines that the processing is not completed, the processing from S513 is repeated. In the case where the image layout unit 314 determines that the processing is completed, the automatic layout processing of FIG. 5 is terminated.

### Effects of First Embodiment

As described above, according to the present embodiment, images can be preferably selected. Differences in effects of image selection between a comparative example and the present embodiment are described below by using diagrams.

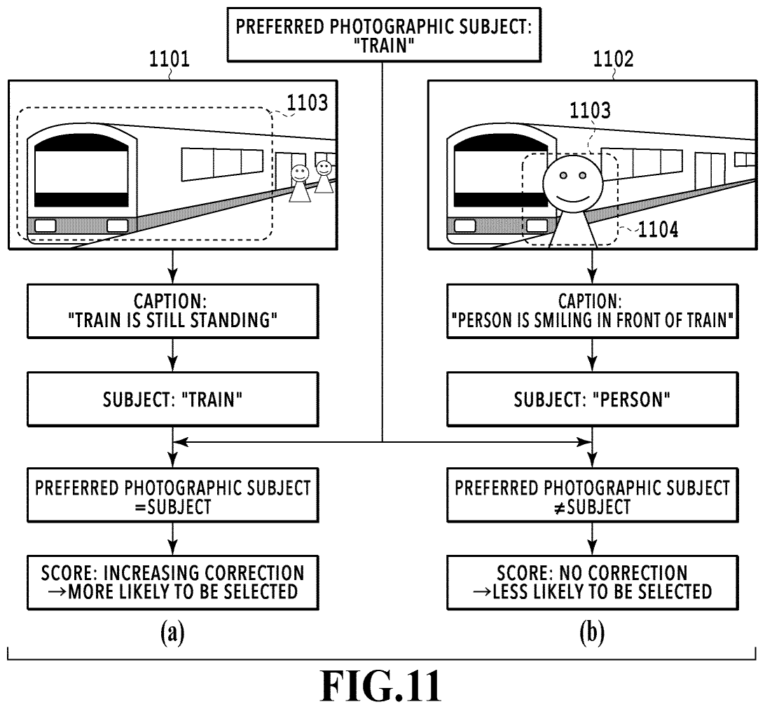

FIG. 11 is diagram explaining effects of the present embodiment. Reference signs 1101 and 1102 denote the same images as those of FIGS. 1A and 1B. In the case where the preferred photographic subject is “train”, an image to be selected is the image 1101, and the image 1102 is an image that would rather not be selected. Conventionally, in the case where the preferred photographic subject is set to “train”, both of the image 1101 and the image 1102 in which a train is captured are likely to be selected. In the present embodiment, the caption linked to each image is obtained in addition to the setting of the preferred photographic subject, the syntax analysis is performed to specify the subject that may be the main photographic subject, and the score of the image in which the subject and the preferred photographic subject match each other is increased. According to this method, it is found from the processing from S505 to S508 that the subject of the image 1101 is a train 1103 and the subject of the image 1102 is a person 1104. Accordingly, the score of the image 1101 in which the preferred photographic subject and the subject that may be the main photographic subject match each other is increased, and the image 1101 becomes more likely to be selected. Meanwhile, the image 1102 becomes less likely to be selected due to no correction of the score. Specifically, the image with the preferred photographic subject more desirable for the user can be selected.

### Second Embodiment

In a second embodiment, the scoring of the images is implemented by using the caption analysis result without execution of the image analysis processing of S503 described in the first embodiment.

A software block diagram of an album creation application in the present embodiment is basically the same as FIG. 3 of the first embodiment. However, since no image analysis processing is performed, the image analysis unit 304 may be omitted.

### <Flow of Processing>

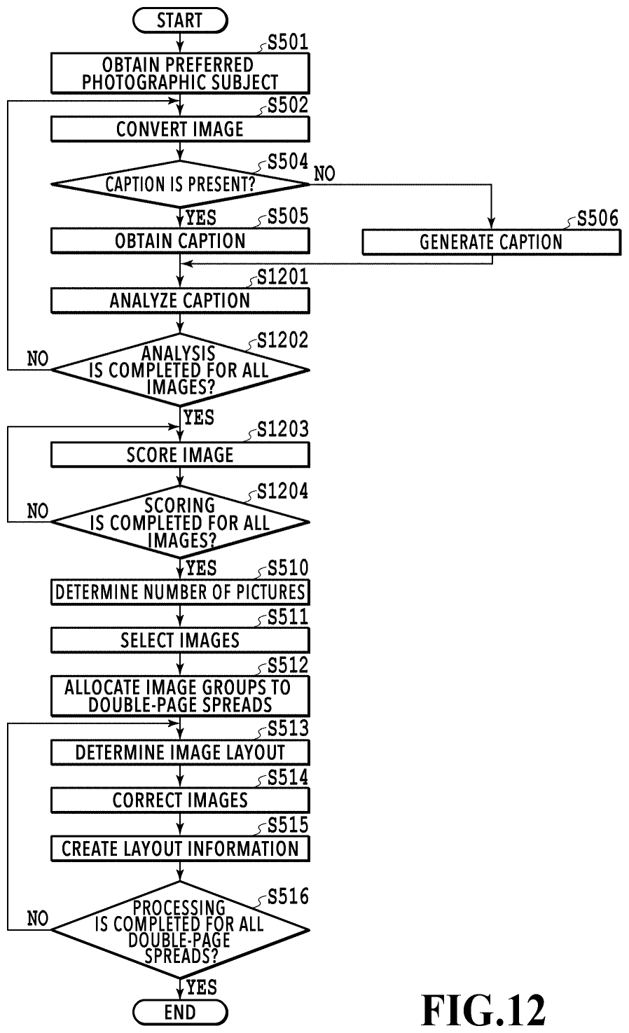

FIG. 12 is a flowchart illustrating processing of the automatic layout processing unit 318 in the album creation application in the second embodiment. The automatic layout processing in the second embodiment is described with reference to FIG. 12. Note that basic processing of the automatic layout processing is the same as that in the example described in the first embodiment, and different points are mainly described below.

In S1201, the caption analysis unit 306 analyzes the caption obtained in S505 or the caption generated in S506 to obtain the caption analysis information. Also in the present embodiment, the caption analysis unit 306 executes the syntax analysis on the caption obtained in S505 or the caption generated in S506 to obtain elements such as a subject, a verb, an object, or a complement in the caption. Then, in the present embodiment, the words being the respective elements are each expressed in the word embedding by using a publicly-known technique. In the present embodiment, the word embedding of the word is implemented by using Word2Vec.

In S1202, the image scoring unit 307 determines whether or not the caption analysis of S1201 is completed for all images in the album candidate image group in the folder designated by the user. In the case where the image scoring unit 307 determines that the caption analysis is not completed, the processing from S502 is repeated. In the case where the image scoring unit 307 determines that the caption analysis is completed, the processing proceeds to S1203.

In S1203, the image scoring unit 307 executes the scoring on the images of the album candidate image group. In the first embodiment, the image scoring unit 307 executes the scoring by using the image feature amounts obtained by analyzing the images and the caption analysis information obtained by analyzing the captions. In the present embodiment, the image scoring unit 307 executes the scoring by using only the caption analysis information.

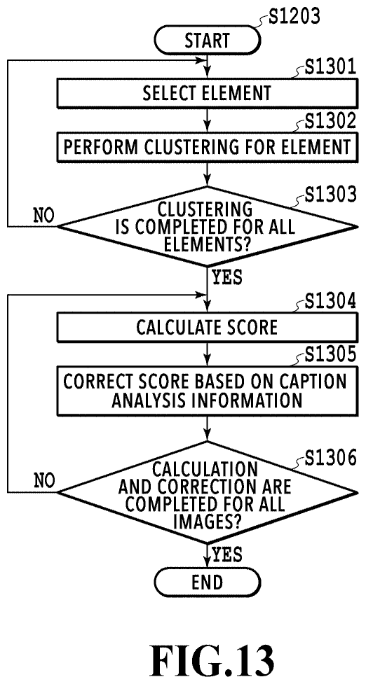

FIG. 13 is a flowchart illustrating details of the scoring processing of S1203. The scoring processing performed in S1203 is described below by using FIG. 13. First, in S1301, the image scoring unit 307 selects one element from the elements (a subject, a verb, an object, or a complement) of the syntax analysis result in the caption analysis information obtained in S1201.

In S1302, the image scoring unit 307 performs clustering for the element selected in S1301 and divides the images depending on clusters. In the present embodiment, a Ward method is used as the clustering method. As a matter of course, the clustering method is not limited to this, and may be, for example, a furthest neighbor method, a k-means method, or the like. In S1303, the image scoring unit 307 determines whether the processing of S1302 is completed for each of the elements in the syntax analysis result. In the case where the image scoring unit 307 determines that the processing is not completed, the processing from S1301 is repeated. In the case where the image scoring unit 307 determines that the processing is completed, the processing proceeds to S1304.

In S1304, the image scoring unit 307 calculates the score of the interest image for each element of the syntax analysis result by using a formula (4).

Skj=50×(Nji/Nk) formula (4)

In this formula, k is an index of an interest image, j is an index of an element of the syntax analysis result, i is an index of a cluster relating to the element j, and Skj is a score of the interest image k for the element j. Moreover, Nk is the number of images included in the album candidate image group, and Nji is the number of interest images included in the cluster i of the element j. According to the formula (4), a higher score is given to an image that includes a word frequently appearing in a caption group linked to the album candidate image group, and such an image is more likely to be selected. Specifically, image selection with uniformness in each element can be implemented.

Then, the image scoring unit 307 calculates the score of each interest image by using the score Skj obtained for each interest image, for each element by using the formula (4) and a formula (5).

Pk=Σj(Sjk)/Nj formula (5)

In this formula, Pk is the score of each interest image, and Nj is the number of items of the elements. Specifically, the score of each interest image is calculated as an average of the scores for the respective elements.

A method of calculating the score by using the formula (4) and the formula (5) is described below by using two interest images as an example. An interest image 1 is assumed to be an image with the syntax analysis result of “a train is running in a mountain”. In the interest image 1, the subject is “train”, the verb is “is running”, and the complement indicating the scene is “mountain”. Assume that the number (Nk) of images included in the album candidate image group is 100 and, as a result of the syntax analysis on the 100 images, the album candidate image group includes 25 images for which the subject is “train”, 10 images for which the verb is “is running”, and five images for which the scene is “mountain”. If the scores for the respective elements in the interest image 1 are calculated by using the formula (4) in this case, the scores are subject=12.5 points, verb=5 points, object=0 points, and scene=2.5 points. The formula (5) is applied to this result, and the average point for the elements is calculated to be Pk=5 points. This point is the score of the interest image 1.

Similarly, an interest image 2 is assumed to be an image for which the result of syntax analysis is “a train is running along a sea coast”. In the interest image 2, the subject is “train”, the verb is “is running”, and the complement indicating the scene is “sea”. Assume that the 100 images in the album candidate image group includes 10 images for which the scene is “sea”. If the scores for the respective elements in the interest image 2 are calculated by using the formula (4) in this case, the scores are subject=12.5 points, verb=5 points, object=0 points, and scene=5 points. The formula (5) is applied to this result, and the average point for the elements is calculated to be Pk=5.6 points. This point is the score of the interest image 2. Accordingly, in the case where the interest image 1 and the interest image 2 are compared to each other, the interest image 2 has the higher score. Thus, the interest image 2 is more likely to be selected at this point. In actual, correction of the score based on the relationship between the preferred photographic subject and the subject to be described below is performed, and the scoring processing is completed.

In S1305, the image scoring unit 307 corrects the score calculated in S1304 based on the caption analysis information obtained in S1202. Also in the present embodiment, as in the first embodiment, the image scoring unit 307 corrects the score based on the relationship between the preferred photographic subject and the subject. Since the specific correction method is the same as that in S904 of the first embodiment, description thereof is omitted.

In S1306, the image scoring unit 307 determines whether or not the processing of S1304 and S1305 is completed for all images in the album candidate image group in the folder designated by the user. In the case where the image scoring unit 307 determines that the processing is not completed, the processing is repeated from S1304. In the case where the image scoring unit 307 determines that the processing is completed, the scoring processing of FIG. 13 is terminated.

Returning to the description of FIG. 12, following S1203, in S1204, the image scoring unit 307 determines whether the image scoring of S1203 is completed for all images in the album candidate image group in the folder designated by the user. In the case where the image scoring unit 307 determines that the processing is not completed, the processing of S1203 is repeated. In the case where the image scoring unit 307 determines that the processing is completed, the processing proceeds to S510. Since the processing hereinafter is the same processing as that in the first embodiment, description thereof is omitted. The automatic layout processing of FIG. 12 is completed at the processing of S516.

### Effects of Second Embodiment

As described above, according to the present embodiment, the automatic layout processing can be performed by using only the caption analysis information without execution of the image analysis processing of S503 in the first embodiment. Accordingly, processing load of the image analysis processing can be eliminated, and an increase in speed of processing can be implemented.

### Modified Example of Second Embodiment

In the aforementioned embodiment, in S1303, the image scoring unit 307 calculates the score of the interest image for each element of the syntax analysis result by using the formula (4) to enable image selection with uniformness. However, the image scoring unit 307 may calculate the score of the interest image for each element of the syntax analysis result by using the following formula (6) instead of the formula (4).

Skj=50×(1−Nji/Nk) formula (6)

According to the formula (6), a higher score is given to an image that includes a word less frequently appearing, that is a word sporadically appearing in a caption group linked to the album candidate image group, and such an image is more likely to be selected. Specifically, it is possible to perform image selection with wider variation in each element.

### Third Embodiment

In a third embodiment, in the caption generation processing of S506 described in the first embodiment, the caption generation is not completed, and information in the middle of generation is extracted and used for the image scoring.

### <Flow of Processing>

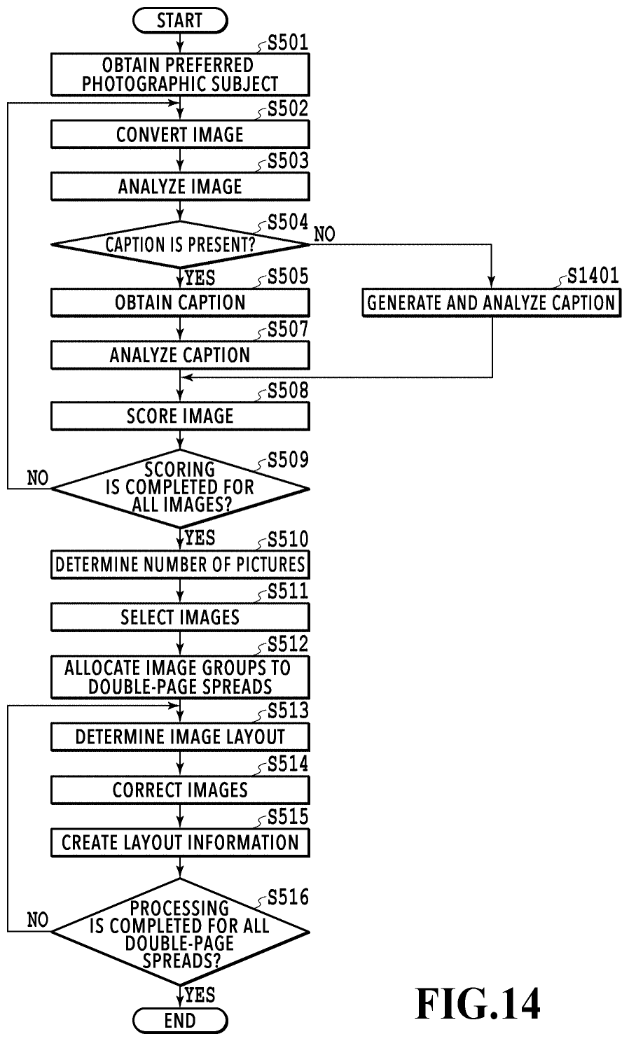

FIG. 14 is a flowchart illustrating processing of the automatic layout processing unit 318 in the album creation application of the third embodiment. The automatic layout processing in the third embodiment is described with reference to FIG. 14. Note that the basic processing of the automatic layout processing is the same as that in the example described in the first embodiment, and different points are mainly described below.

In S1401, the caption generation unit 319 automatically generates and analyzes the caption of each image. Also in the present embodiment, the caption is automatically generated by using the Show and Tell model described in Oriol Vinyals, Alexander Toshev, Samy Bengio, and Dumitru Erhan. “Show and Tell: A Neural Image Caption Generator”, 2015 IEEE Conference on Computer Vision and Pattern Recognition (CVPR), 2015, pp. 3156-3164.

In the Show and Tell model, a word string with high appearance probability can be obtained during a process up to a point where the generation of the caption is completed to the end of the sentence. In the present embodiment, the subject is estimated before the completion of the caption generation by using information obtained during the caption generation process, based on the aforementioned characteristics in the caption generation model.

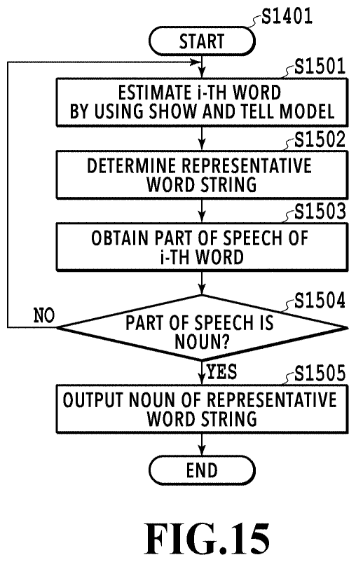

FIG. 15 is a diagram illustrating caption generation and analysis processing. The caption generation and analysis processing performed in S1401 is described below by using FIG. 15. In S1501, the caption generation unit 319 estimates the i-th word by using the Show and Tell model. In the Show and Tell model, multiple high-ranking words are set as candidates based on the appearance probabilities of the words known from the output of the LSTM, and are combined with the estimated word candidates up to (i−1)th word to estimate multiple word string candidates.

In S1502, the caption generation unit 319 determines such a word string that a product of the appearance probabilities of the words included in the word string is greatest, from among the multiple word string candidates estimated up to the point of the (i−1)th word, as a representative word string. Specifically, the caption generation unit 319 determines the word string estimated to be most suitable as the caption, from among the multiple word string candidates. At this point, the processing proceeds to S1503 with no word estimation performed for the i-th word and beyond.

In S1503, the caption generation unit 319 obtains a part of speech of the i-th word in the representative word string. The part of speech is a group obtained by classifying words based on grammar such as a noun or a verb. In the present embodiment, correspondence relationships between words and parts of speech are retained in advance in the ROM 202, and the parts of speech are obtained based on the estimated words. Alternatively, as another method of obtaining the part of speech, there may be employed a method in which morphological analysis is performed on the representative word string and the part of speech estimated for the i-th word is obtained. The morphological analysis is processing of dividing a sentence of a natural language written with characters into smallest meaningful linguistic units (morphemes).

In S1504, the caption generation unit 319 determines whether or not the part of speech of the i-th word obtained in S1503 is a noun. A word determined to be a noun has a possibility of being a subject in a word string. In the case where the part of speech is determined to be a noun, the processing proceeds to S1505. In the case where the part of speech is determined not to be a noun, the processing from S1501 is repeated. In S1505, the caption generation unit 319 outputs the i-th word of the representative word string that is determined to be a noun in S1504. After completion of the processing of S1505, the caption generation and analysis processing of FIG. 15 is terminated. According to the aforementioned method, it is possible to output a noun (subject) of the representative word string in the word estimation up to the i-th word.

Although the part-of-speech obtaining processing of S1503 and the noun determination processing of S1504 are performed after the representative word string determination processing of S1502 in the present embodiment, the representative word string determination processing of S1502 may be performed after the noun determination processing of S1504. Specifically, the processing may be such that the part-of-speech obtaining processing of S1503 and the noun determination processing of S1504 are performed for each of multiple word string candidates, and the representative word string determination processing of S1502 is performed on one or multiple word string candidates in which the parts of speech are determined to be nouns. According to this method, the noun determination processing of S1504 can be executed on more word strings. Accordingly, nouns can be outputted in fewer steps in some cases.

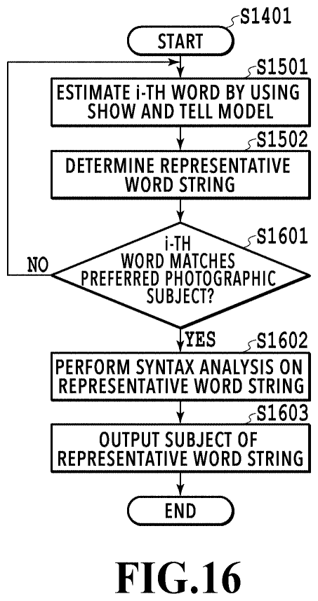

FIG. 16 is a diagram illustrating caption generation and analysis processing using a method different from that of FIG. 15. The caption generation and analysis illustrated in FIG. 15 can be executed also by using a processing flow illustrated in FIG. 16 as described below. Note that the processing is partially the same as the example described in FIG. 15, and different points are mainly described below.

In S1601, the caption generation unit 319 determines whether or not the i-th word in the representative word string obtained in S1502 matches the preferred photographic subject obtained in S501. In the case where the caption generation unit 319 determines that the i-th word matches the preferred photographic subject, the caption generation unit 319 can estimate that the i-th word of the representative word string is to be the subject in the syntax analysis, even if the word estimation for the representative word string is completed only up to the i-th word. In the case where the caption generation unit 319 determines that the i-th word matches the preferred photographic subject, the processing proceeds to S1602. In the case where the caption generation unit 319 determines that the i-th word does not matches the preferred photographic subject, the processing from S1501 is repeated.

In S1602, the caption generation unit 319 executes the syntax analysis on the representative word string. In S1603, the caption generation unit 319 outputs a word determined to be a subject as a result of the syntax analysis in S1602. After completion of the processing of S1603, the caption generation and analysis processing of FIG. 16 is terminated. Also in the method of FIG. 16, as in FIG. 15, the subject of the representative word string can be outputted even if the word estimation is performed only up to the i-th word. Accordingly, the processing can be shortened.

Returning to the description of FIG. 14, the subject information estimated in S1401 is added to the caption analysis information obtained S507 and is used for the image scoring in S508. Then, the automatic layout processing of FIG. 14 is completed at the processing of S516. Although the Show and Tell model is used as the caption generation model in the present embodiment, the model is not limited to this. There may be used other caption generation models that can obtain information in the middle of caption generation such as in a state where a subject can be estimated.

Moreover, the estimation of a subject in the middle of caption generation executed in the present embodiment can be used also in the case where a caption is generated in the first or second embodiment, and enables faster execution of the caption analysis processing.

### Effects of Third Embodiment

As described above, according to the present embodiment, it is possible to extract the information in the middle of caption generation without waiting for the completion of the caption generation processing and use the information for the image scoring. Accordingly, the processing load relating to the caption generation processing can be reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-212731, filed Dec. 27, 2021, which is hereby incorporated by reference wherein in its entirety.

What is claimed is:

1. A method of controlling an image processing apparatus, comprising:
obtaining a candidate image group including a plurality of images;
determining a specific condition for preferentially selecting an image from the candidate image group:
analyzing the images in the candidate image group;
analyzing captions attached to the images in the candidate image group; and
selecting a specific image from the candidate image group based on results of the determining the specific condition, the analyzing the images, and the analyzing the captions.

2. The method of controlling an image processing apparatus according to claim 1, wherein the specific condition includes a setting of a preferred photographic subject for preferentially selecting the specific image.

3. The method of controlling an image processing apparatus according to claim 2, wherein, in the analyzing the captions, each of the captions is segmented into words and a subject of the image in the candidate image group is determined.

4. The method of controlling an image processing apparatus according to claim 3, wherein, in the selecting the specific image, in the case where the subject of the image in the candidate image group determined in the analyzing the captions matches the preferred photographic subject, the image is preferentially selected.

5. The method of controlling an image processing apparatus according to claim 1, further comprising generating a caption in the case where there is an image in the candidate image group to which no caption is given.

6. The method of controlling an image processing apparatus according to claim 5, wherein, in the generating the caption, the caption of the image is generated by using a Show and Tell model.

7. The method of controlling an image processing apparatus according to claim 6, wherein, in the analyzing the captions, the caption generated in the generating the caption is also analyzed.

8. The method of controlling an image processing apparatus according to claim 1, wherein, in the analyzing the images, estimation of a degree of in-focus, face detection, personal recognition, or object determination of each of the images is performed.

9. The method of controlling an image processing apparatus according to claim 1, wherein the specific condition includes a degree of in-focus, the number of faces, or an object of the image.

10. The method of controlling an image processing apparatus according to claim 5, wherein, in the analyzing the captions, the caption is analyzed in middle of the generating the caption.

11. A method of controlling an image processing apparatus, comprising:
obtaining a candidate image group including a plurality of images;
determining a specific condition for preferentially selecting an image from the candidate image group:
analyzing captions attached to the images in the candidate image group; and
selecting a specific image from the candidate image group based on results of the determining the specific condition and the analyzing the captions.

12. The method of controlling an image processing apparatus according to claim 11, wherein the specific condition includes a setting of a preferred photographic subject for preferentially selecting the specific image.

13. The method of controlling an image processing apparatus according to claim 12, wherein, in the analyzing the captions, each of the captions is segmented into words and a subject of the image in the candidate image group is determined.

14. The method of controlling an image processing apparatus according to claim 13, wherein, in the selecting the specific image, in the case where the subject of the image in the candidate image group determined in the analyzing the captions matches the preferred photographic subject, the image is preferentially selected.

15. The method of controlling an image processing apparatus according to claim 11, further comprising generating a caption in the case where there is an image in the candidate image group to which no caption is given.

16. The method of controlling an image processing apparatus according to claim 15, wherein, in the generating the caption, the caption of the image is generated by using a Show and Tell model.

17. The method of controlling an image processing apparatus according to claim 16, wherein, in the analyzing the captions, the caption generated in the generating the caption is also analyzed.

18. The method of controlling an image processing apparatus according to claim 14, wherein, in the analyzing the captions, the caption is analyzed in middle of the generating the caption.

19. An image processing apparatus, comprising:
an obtaining unit configured to obtaining a candidate image group including a plurality of images;
a determining unit configured to determining a specific condition for preferentially selecting an image from the candidate image group:
an image analyzing unit configured to analyzing the images in the candidate image group;
a caption analyzing unit configured to analyzing captions attached to the images in the candidate image group; and
a selecting unit configured to selecting a specific image from the candidate image group based on results of the determining unit, the image analyzing unit, and the caption analyzing unit.

20. A non-transitory computer readable storage medium storing a program which causes a computer to function as
an obtaining unit configured to obtaining a candidate image group including a plurality of images;
a determining unit configured to determining a specific condition for preferentially selecting an image from the candidate image group:
an image analyzing unit configured to analyzing the images in the candidate image group;
a caption analyzing unit configured to analyzing captions attached to the images in the candidate image group; and
a selecting unit configured to selecting a specific image from the candidate image group based on results of the determining unit, the image analyzing unit, and the caption analyzing unit.

21. An image processing apparatus, comprising:
an obtaining unit configured to obtaining a candidate image group including a plurality of images;
a determining unit configured to determining a specific condition for preferentially selecting an image from the candidate image group:
a caption analyzing unit configured to analyzing captions attached to the images in the candidate image group; and
a selecting unit configured to selecting a specific image from the candidate image group based on results of the determining unit and the caption analyzing unit.

22. A non-transitory computer readable storage medium storing a program which causes a computer to function as
an obtaining unit configured to obtaining a candidate image group including a plurality of images;
a determining unit configured to determining a specific condition for preferentially selecting an image from the candidate image group:
a caption analyzing unit configured to analyzing captions attached to the images in the candidate image group; and
a selecting unit configured to selecting a specific image from the candidate image group based on results of the determining unit and the caption analyzing unit.
